(19) United States
(12) Patent Application Publication
(10) Pub. No.: US 2009/0021051 A1
(43) Pub. Date: Jan. 22, 2009

(54) WINDOW ASSEMBLY FOR A UTILITY TERRAIN VEHICLE

(76) Inventor: Steve H. Brown, Kennett, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/175,918

(22) Filed: Jul. 18, 2008

Related U.S. Application Data
(60) Provisional application No. 60/951,087, filed on Jul. 20, 2007.

(51) Int. Cl. B60J 1/00

(52) U.S. Cl. 296/201

(57) ABSTRACT

A shield/window assembly for a utility terrain vehicle (UTV) includes a frame having a rigid body and four perimeter portions, a screen member attached to the frame and having a permeable body, and a fastening member attached to the frame and adapted for releasably coupling to a mating member of the vehicle.

### CROSS-REFERENCE TO RELATED APPLICATIONS

This application claims the benefit of U.S. Provisional Application No. 60/951087, filed on Jul. 20, 2007 and entitled SCREEN SHIELD ASSEMBLY FOR A UTILITY TERRAIN VEHICLE, the disclosure of which is incorporated herein by reference.

### FIELD

The present disclosure relates generally to utility vehicles and, more specifically, to a screen shield assembly for a utility terrain vehicle for providing protection from debris to a utility vehicle driver while allowing airflow into the cab area.

### BACKGROUND

The statements in this section merely provide background information related to the present disclosure and may not constitute prior art.

Utility terrain vehicles typically include a body and a cab where the driver and one or more passengers are seated. A roll cage is also often provided that surrounds the cab area. Typically all terrain or utility terrain vehicles however are not designed to protect the driver and passengers from debris (e.g. bugs, rocks, branches) during operation of the vehicle.

To this means, cab enclosures and lightweight transparent windshields have been developed that can be attached to the roll cage to protect the driver and passengers from debris. These devices are typically comprised of a transparent plastic material such as a plastic or Plexiglas. However, these transparent devices reduce the passage of air into the cab area and can cause dust and debris to flow into and collect within the cab area. Additionally, during operation of the vehicle with such a windshield during hot weather, the reduced airflow into the cab area can be very uncomfortable for the driver and passengers. Some permeable screens have been used on utility and related vehicles, however, such screens are often difficult to install and uninstall and require the placement of unsightly brackets onto the vehicle that remain on the vehicle even after removal of the screen.

### SUMMARY

Recognizing problems and limitations of the current art, the inventor hereof has succeeded at designing a permeable screen shield assembly for a utility terrain vehicle and/or all terrain vehicles that is capable of protecting the driver and passengers from debris and wind while allowing for airflow through the screen. Such allowed airflow can prevent the incursion of dust and debris into the cab and cool the driver and passengers during operation of a utility terrain vehicle (UTV).

According to one aspect, a shield assembly for a utility terrain vehicle (UTV) includes a frame having a rigid body and four perimeter portions, a screen member attached to the frame, the screen member having a permeable body, and a fastening member is attached to the frame. The fastening member is adapted for releasably coupling to a mating member of the vehicle.

According to another aspect, a window assembly for a utility terrain vehicle (UTV) includes a frame having a rigid body and four perimeter portions with each portion including a groove. The frame is dimensioned for positioning a portion of the frame between two upright supports of a cab of the vehicle. An elongated spline member is adapted for positioning within the grooves of the perimeter portions. A screen member has a permeable body attached to the frame. A portion of the screen member is positioned within the grooves of each of the four perimeter portions and is secured within the grooves by the spline member. A fastening hook and loop member is attached to the frame and is adapted for releasably coupling to an opposing hook and loop member of the vehicle.

According to yet another aspect, a window assembly for a utility terrain vehicle (UTV) includes means for mounting a permeable screen to a rigid frame and means for releasably mounting the rigid frame with the permeable screen to a vehicle.

According to yet another aspect, a utility terrain vehicle (UTV) including a vehicle assembly includes an engine and frame, a seat for a driver, a load carrying platform behind the seat, and a cab frame surrounding the seat and having two upright supports positioned about the seat. The vehicle also includes mating members that are attached to front surfaces of the two upright supports and being at least one portion of a hook and loop fastening system. The vehicle further includes a screen shield having a rigid body with four perimeter portions, a screen member with a permeable body attached to the four perimeter portions of the frame, and fastening members attached to the rigid body. The fastening members have a second mating portion of the hook and loop fastening system that is opposite of that of the mating members. The screen shield is adapted for releasably mounting to the two upright supports via the mating members.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 illustrates a front view (FIG. 1A), an end view (FIG. 1B) and a top view (FIG. 1C) of a shield/window assembly for a utility terrain vehicle according to one exemplary embodiment.

FIG. 2 is a front perspective view of a segmented assembled shield according to one exemplary embodiment.

FIG. 3 is a perspective view of a segmented rigid body showing two of the corner portions of a shield assembly according to some embodiments.

FIG. 4A is an end cross sectional view of a rigid frame portion according to one exemplary embodiment.

FIG. 4B is an end cross-sectional view of a mounting of a screen member within a groove of the rigid frame portion of FIG. 3A and being secured in the groove by a spline according to some exemplary embodiments.

FIGS. 5A-5C are end perspective views of additional exemplary embodiments of rigid frame portions with grooves.

FIGS. 6A-6D are perspective views of corner connectors for a body of the rigid frame according to various exemplary embodiments.

FIG. 7 illustrates cross-sectional views of various exemplary mounting structures suitable for use with rigid frame portions for forming a rigid body according to various exemplary embodiments.

FIG. 8 is a front view of a utility terrain vehicle (UTV) configured with a shield assembly according to one exemplary embodiment.

FIG. 9 is a front perspective view of another utility terrain vehicle (UTV) configured with a shield/window assembly according to another exemplary embodiment.

FIG. 10 is a side perspective view of another utility terrain vehicle (UTV) configured with a shield/window assembly according to another exemplary embodiment.

FIG. 11 is a rear perspective view of a utility terrain vehicle illustrating a part of shield/window assemblies equipped at the front and the rear of a utility terrain vehicle (UTV) cab according to yet another exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

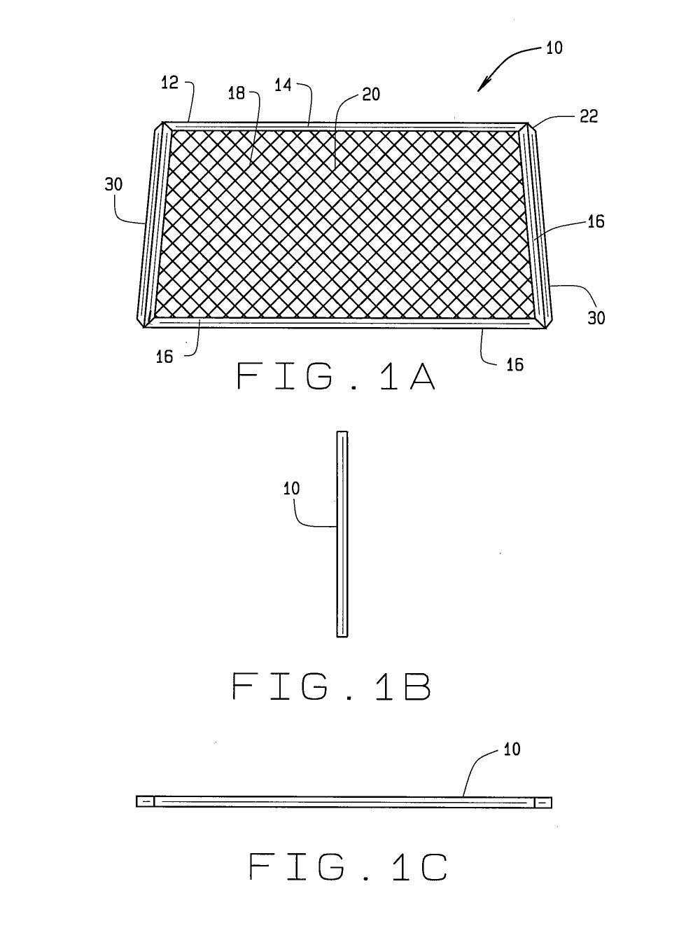

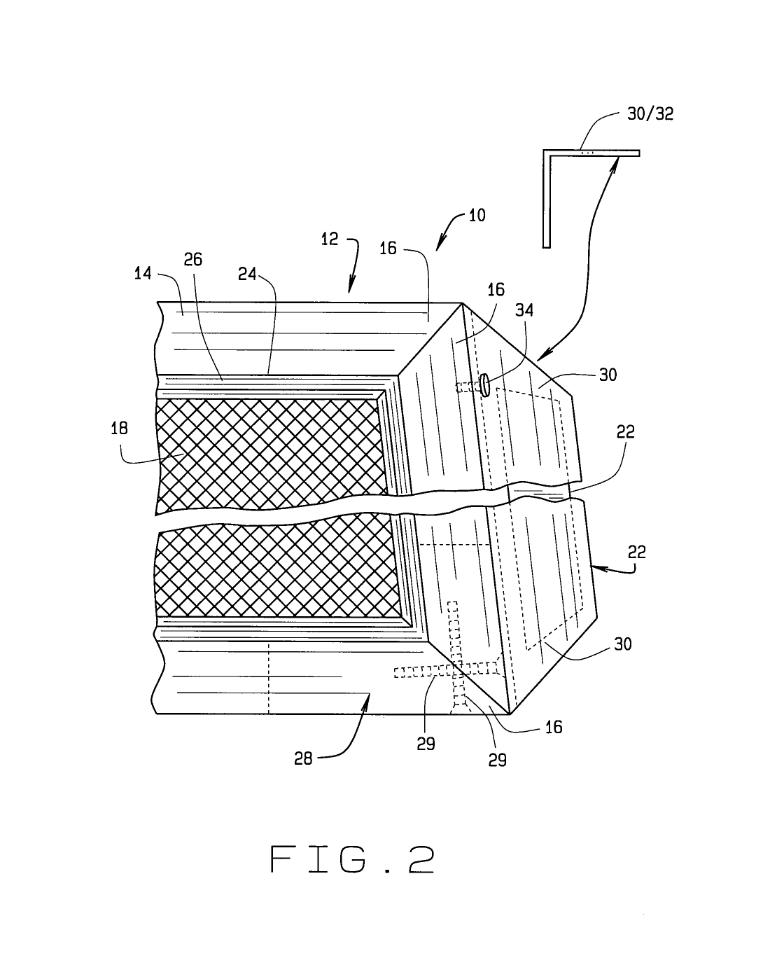

In some embodiments such as shown by way of example in FIGS. 1 and 2, a shield/window assembly 10 for a utility terrain vehicle (UTV) (not shown) includes a frame 12 having a rigid body 14 and four perimeter portions 16. The frame 12 and its rigid body 14 and the perimeter portion 16 can be constructed from any suitable material and can include a metal such as an aluminum or steel, a composite material, a plastic including a vinyl.

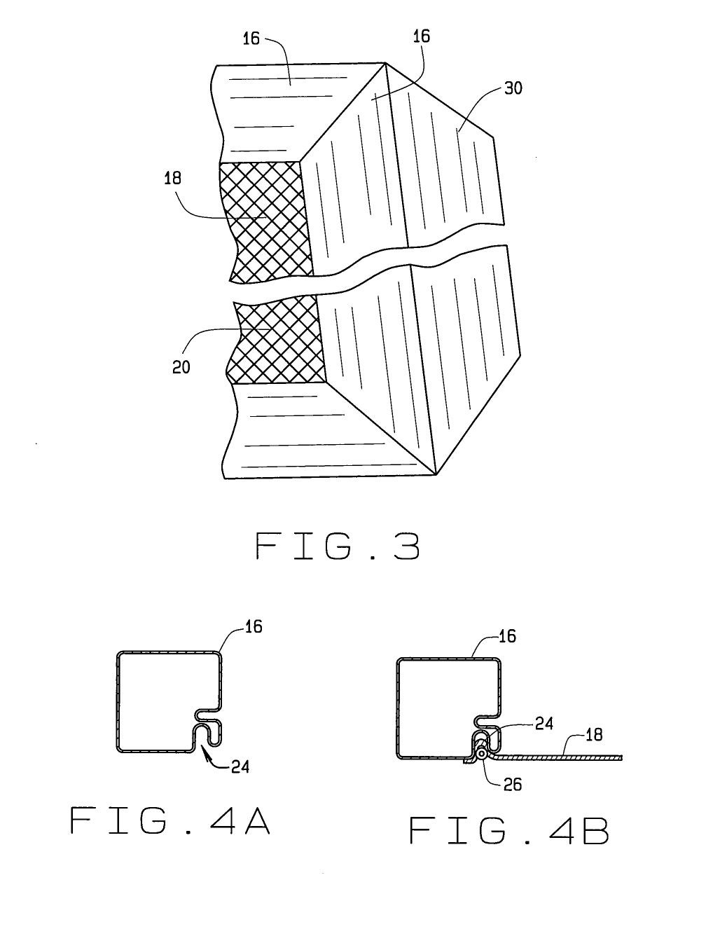

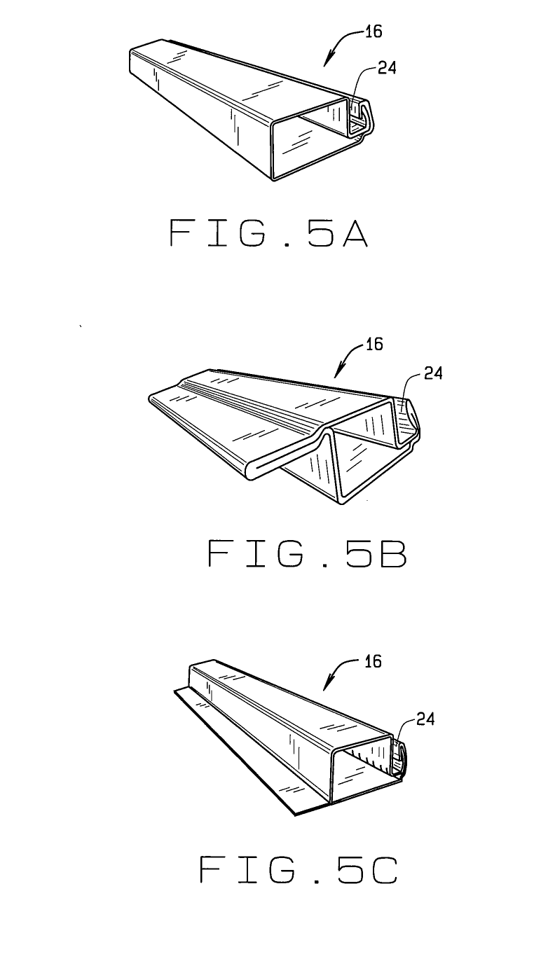

As shown in FIG. 1, four perimeter portions 16 of the frame 12 can include a top portion, a bottom portion, and two side portions. The frame 12 and its perimeter portions 16 can be of any design, shape or configuration. FIGS. 2 and 3 illustrate some examples of a frame 12 and FIGS. 4A and 5A, 5B, and 5C illustrate some examples of perimeter portions 16, each of these including exemplary embodiments with a groove as will be discussed below. In some embodiments, the frame 12 is dimensioned for placement of a substantial portion of the rigid body 14 between two uprights structures of a cab of the vehicle. Generally, it may be desirable for the dimensions of the frame 12 to be configured such that a screen member 18 mounted to the frame 12 can be positioned in a plane defined by the front surfaces of the two upright structures or slightly offset therefrom and substantially parallel to the plane as defined by front surfaces of the two upright structures. The dimensions shown in FIG. 1, as well as throughout the figures and this specification, are only illustrative and are not limiting in nature and not intended to represent anything more than one exemplary embodiment.

The screen member 18 is attached to the rigid body 14 to form the frame 12. The screen member 18 has a permeable body 20. The permeable body 20 can be of any material and can include a permeable aluminum mesh, vinyl mesh, polypropylene mesh, and fiberglass mesh, by ways of examples. The screen member 18 can be attached to the rigid body 14 of the frame 12 by any suitable method including by fasteners or adhesives, as are known to those skilled in the art.

As shown in FIG. 2, in some embodiments the frame 12 can include a groove 24 for receiving a portion of the screen member 18. The screen member may be attached directly to the frame 12. However, in other embodiments, a spline member 26 can be positioned within a groove 24 of the frame 12 along with a portion of the received screen member 18. The spline member 26 can cooperate with the groove 24 to secure the portion of the received screen member 18 within the groove 24. The spline member 26 can be of any suitable type for insertion in and securement within the groove 24 and can include a rubber, a polypropylene, silicon, and a plastic. These can be in a solid form or can be in a compressible or foam form and can take the form of an elongated member suitable for insertion in the groove 24.

One or more corner connectors 28 can be coupled to two adjacent perimeter portions 16 for forming a corner of the frame 12. These corner connectors 28 can be composed of any suitable material and can include, by ways of example, a wood, a plastic, a composite, and a metal. FIGS. 2 (shown in phantom), 6A, 6B, 6C, and 6D provide some exemplary illustrations of various designs and configuration of corner connectors 28 for coupling two adjacent perimeter portions 16 together for forming the rigid body 14. Of course other designs are also possible and considered to be within the scope of this disclosure. The corner connectors 28 can be coupled to each adjacent perimeter portion 16 via fasteners 29 or by an adhesive or similar method of attachment.

A fastening member 22 is attached to the frame 12 and is adapted for releasably coupling to a mating member (not shown) of the vehicle. The fastening member 22 can be one portion of a hook and loop fastening material (shown in FIG. 2 in partial phantom and in the break-away portion) that can be configured for engaging with a mating portion of the hook and loop fastening material that is a part of or attached to the vehicle. The fastening member 22 can be attached to the frame 12 with any suitable fastening method and can include adhesives or other suitable means.

The fastening member 22 can be mounted directly to one or more of the portions 16 of the frame 12 or its rigid body 14. However, in some embodiments the rigid body 14 can include the perimeter portions 16 and one or more mounting structures 30 attached to the rigid body 14 or one or more of the portions 16. In such an embodiment, the fastening member 22 can be attached to the frame 12 by way of the attachment to the mounting structure 30. Such a mounting structure 30 is illustrated in FIGS. 2, 3, and 7 by ways of example. In other embodiments, the rigid body 14 and/or one or more of the perimeter portions 16 can include an integrated or attached mounting structure 30 that defines or includes a flange 32. Each perimeter portion 16 can include a first side coupled to a first side of the flange 32 with a plurality of fasteners 34 and a second side of the flange 32 having the fastening member 22 attached thereto.

In some embodiments as described herein, a window assembly for a utility terrain vehicle (UTV) includes a frame having a rigid body and four perimeter portions with each portion including a groove. The frame is dimensioned for positioning a portion of the frame between two upright supports of a cab of the vehicle. An elongated spline member is adapted for positioning within the grooves of the perimeter portions. A screen member has a permeable body attached to the frame. A portion of the screen member is positioned within the grooves of each of the four perimeter portions and is secured within the grooves by the spline member. A fastening hook and loop member is attached to the frame and is adapted for releasably coupling to an opposite hook and loop member of the vehicle.

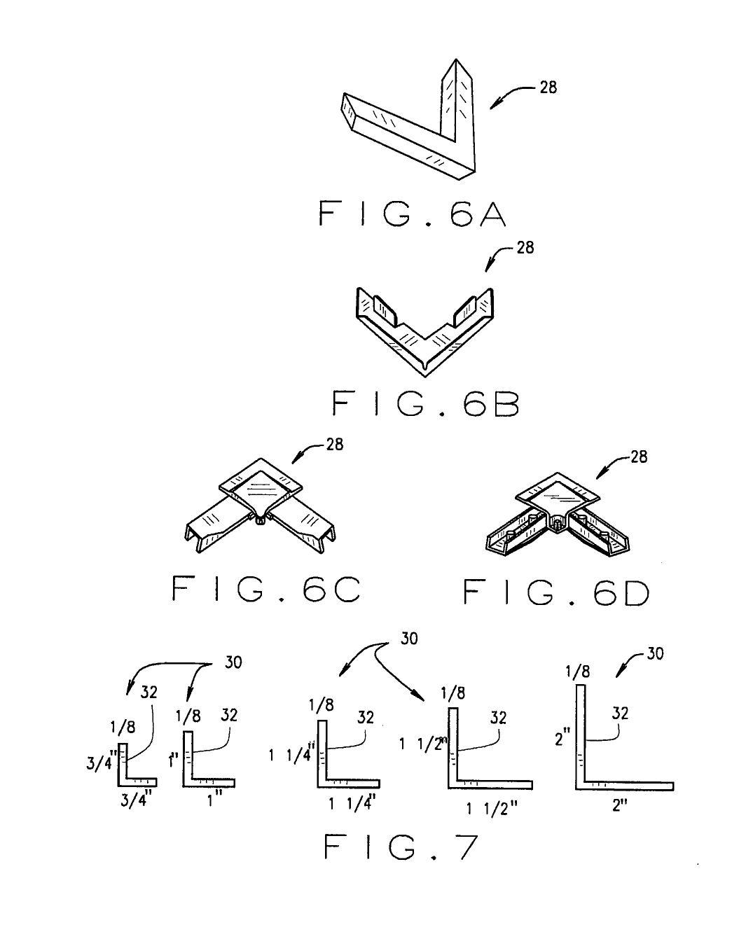

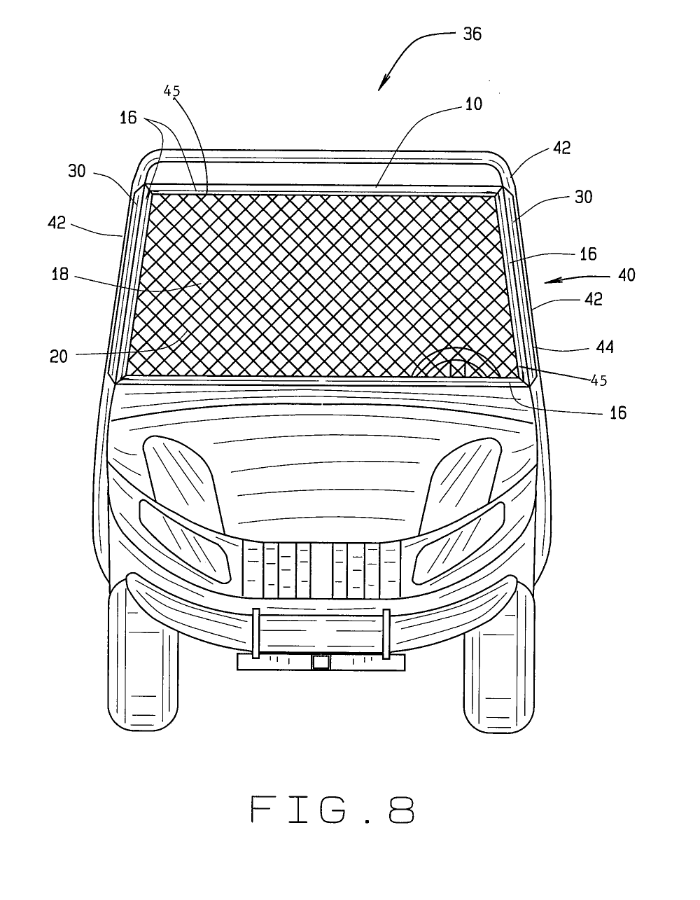

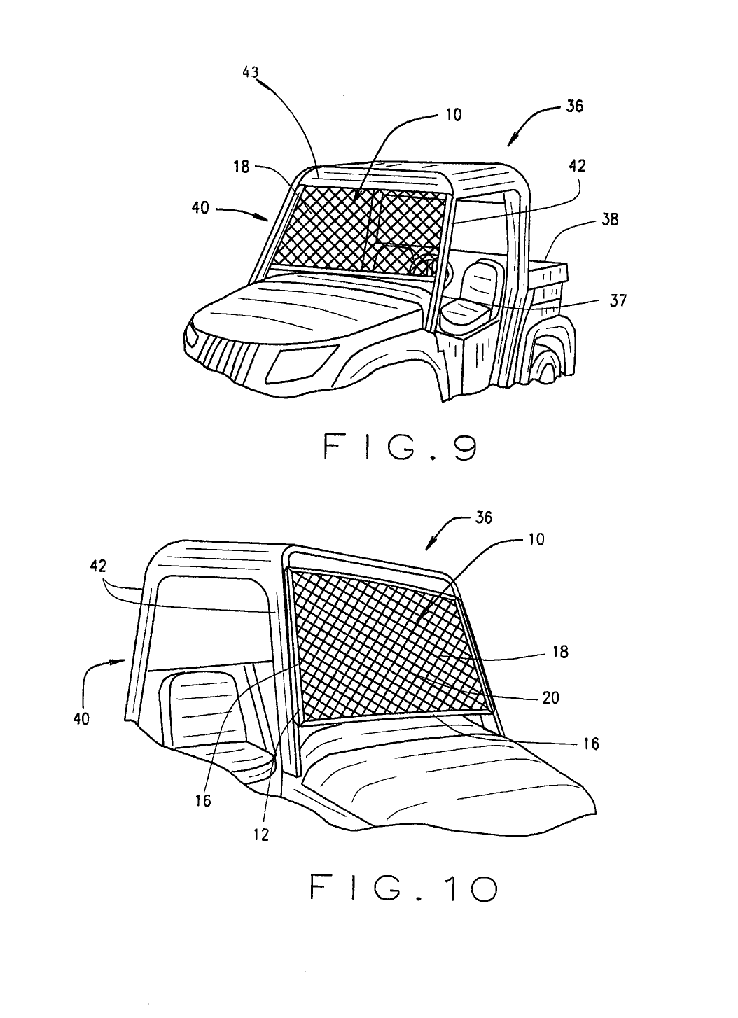

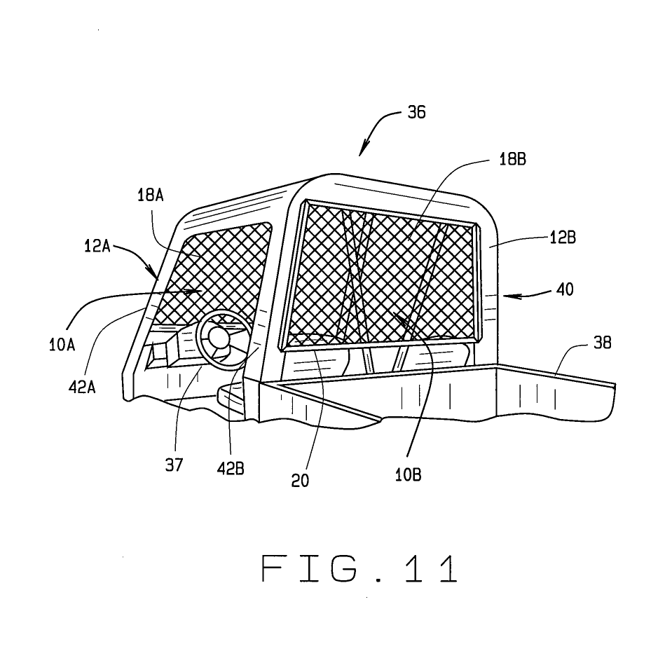

As described above, FIGS. 1-7 illustrate various exemplary configurations of a shield/window assembly for a utility terrain vehicle (UTV). Such a shield/window assembly can be attached to the vehicle, as illustrated by way of examples in FIGS. 8-11. As known, a utility terrain vehicle assembly 36 includes an engine and frame, a seat 37 for a driver as shown in FIGS. 9 and 11, a load carrying platform 38 behind the seat 37, and a cab (or cab frame) 40 surrounding the seat 37. The cab 40 can include two or more upright supports 42 positioned about the seat 37. The vehicle 36 also includes mating members 44 that are attached to surfaces of two or more upright supports 42. The mating members 44 can be a mating portion of a hook and loop fastening system of the fastening member 22. The vehicle assembly 36 includes a shield/window assembly 10 having a frame 12 with a rigid body 14 with four perimeter portions 16, a screen member 18 with a permeable body 20 attached to the four perimeter portions 16 of the frame 12. The fastening members 22 are attached to the rigid body 14, the frame 12, and/or the perimeter portions 16. The fastening members 22 have a second mating portion of the hook and loop fastening system that is opposite of that of the mating members 44. The shield window assembly 10 is adapted for releasably mounting to two or more upright supports 42 via the mating members 44.

FIGS. 8, 9, and 10 illustrate a UTV equipped with a shield/window assembly 10 placed as a windshield in front of the cab 40 and the driver's seat 37. FIG. 8 illustrates a shield/window assembly 10 mounted to the two front uprights 42 of the cab 40 forming a permeable “wind shield” for the cab 40. Additionally, a non-permeable member 45 can be selectably and/or removably positioned or mounted on the frame 12 such as to the rigid body 14 on an outer or inner side of the permeable screen member 18. The non-permeable member 45 can be composed of any suitable material such as, by way of example, plexiglass, plastic, glass, or otherwise. As shown in FIG. 8, the non-permeable member 45 can be positioned, by way of example, on the outer surface of the frame 12 by attachment to the rigid frame 14 via one or more attachment means such as by a hook and loop fastening material, or any other suitable fastening devices (not shown). The non-permeable member 45 can be mounted or added by a user to provide complete protection from the elements or to completely block the wind such as during the winter or during periods of rain without having to remove the shield/window assembly 10.

FIG. 9 illustrates that cab 40 can include a cab cover 43 that can partially cover and/or secure or enclose the top portion of the shield/window assembly 10. FIG. 10 illustrates the mounting of the shield/window assembly 10 with a cab cover 43 that covers the cab 40 but does not cover or secure the shield/window assembly 10.

FIG. 11 illustrates a UTV 36 equipped with both a front shield/window assembly 10A with a front screen member 18A attached to front upright supports 42A, as well as a rear shield/window assembly 10B with a rear screen member 18B attached to rear upright supports 42B. In such an exemplary embodiment, the cab 40 of UTV 36 has both front and rear protection from dust and debris while providing a full flow of air through the front shield/window assembly 10A and out the rear shield/window assembly 10B that can provide for cooling the driver and passengers among other benefits. For example, the flow thru air can also provide a front to rear airflow over the load carrying platform 38 that can also aid in minimizing debris or the contents within the load carrying platform 38 from flowing back into the cab 40. The flow thru air can also act as an inhibitor for debris such as dust from entering the cab 40 through the side openings. It should be understood to one skilled in the art that, while not illustrated in FIG. 11, one or both of the shield/window assemblies 10A and 10B can include a removably mounted non-permeable member in addition to the screen members 18A and 18B.

Generally as described in the above discussion, in the embodiments having fastening members 22 and mating members 44 of the hook and loop configuration, this can be of any type as is known in the art. However, it should be understood that fastening members 22 and 44 can also include any suitable fastening mechanisms including screws, nuts and bolts, latches, snaps, etc. However, in some embodiments, these fastening members have been implemented as hook and loop fastening tape with two mating strips of narrow fabric fasteners. One side is the loop fastener, which is the soft fuzzy side, and the other side is the hook fastener, which is the hard rough side. When the two mating members 22 and 24 are engaged, hundreds of hooks engage with hundreds of loops to form a strong bond or fastener for attaching the screen shield to the vehicle. When pulled apart, the nylon hook straightens out in order to release from the loop and once released the hook returns to its natural state in the shape of a hook. The release of the hook and loop fastening members 22 and 44 generally can provide a ripping sound that is actually the breaking of some of the loops that are engaged with the hooks. An adhesive can be utilized on the back of each of the fastening members 22 and 44 for mounting or attaching to the frame 12. For example, a pressure sensitive adhesive can be rubber-based and can permanently bond to about 95% of the substrates including metal. Fastening members 22 and 44 can be hook and loop fasteners that are “generic” or can include the well known branded Velcro® Brand fasteners (Velcro is a registered trademark of Velcro Industries B.V. LTD LIAB CO NETHERLANDS) or VELTEX® Brand Loop, (Veltex is a registered trademark of Velcro Industries B.V. LTD LIAB CO NETHERLANDS), by ways of examples.

As to the spline members 26, there are various known spline materials. This can be a rubber or polypropylene spline material or a foam or polyfoam spline material. Generally, the spline member 26 is adapted for fitting the groove 24 in the frame 12 or the perimeter portions 16 thereof. A spline roller can be used to push the spline member 26 into the groove 24. The spline roller looks like a double-ended pizza cutter. The spline member 26 can be laid out along a groove 24 of a first perimeter portion 16 and then pushed into place with the roller. Then the same spline member 26 or a different spline member 26 can be pushed into place in another one of the perimeter portions 16 defining the frame 12.

As can be seen from this disclosure, a shield/window assembly and vehicle equipped therewith can provide improvements in safety and user comfort as compared to previously known window systems and assemblies for utility terrain vehicles. Various embodiments can be durable, easily attached and detached from a vehicle and can be produced from available materials at a relative low and competitive cost as compared to alternative assemblies.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. An assembly for a utility terrain vehicle (UTV) comprising:
a frame having a rigid body and four perimeter portions;
a screen member attached to the frame, the screen member having a permeable body; and
a fastening member attached to the frame and adapted for releasably coupling to a mating member of the vehicle.

2. The assembly of claim 1 wherein the permeable body of the screen member is selected from the group consisting of aluminum mesh, vinyl mesh, polypropylene mesh, and fiberglass mesh.

3. The assembly of claim 1, further comprising a non-permeable member removably mounted to the frame and substantially parallel to the screen member.

4. The assembly of claim 1 wherein the frame includes a groove for receiving a portion of the screen member, further comprising a spline member positioned within the groove along with the portion of the received screen member, the spline member cooperating with the groove to secure the portion of the received screen member within the groove.

5. The assembly of claim 4 wherein the spline member is selected from the group consisting of a rubber, a polypropylene, silicon, and a plastic.

6. The assembly of claim 1 wherein the fastening member is at least one of a hook fastening material and a loop fastening material, the fastening member being one of a pair of hook and hoop fasteners with the mating member being the opposite member, the fastening member material being attached to the frame with an adhesive.

7. The assembly of claim 1 wherein the frame includes four perimeter portions, a top portion, a bottom portion, and two side portions, further comprising a corner connector coupled to each of two of the adjacent perimeter portions for forming a corner to the frame.

8. The assembly of claim 7 wherein the corner connector is selected from the group consisting of wood, plastic, composite, and metal.

9. The assembly of claim 1 wherein the rigid body includes a mounting structure attached to one or more of the four perimeter portions, and wherein the fastening member is attached to the frame by way of the mounting structure.

10. The assembly of claim 9 wherein the four perimeter portions of the frame includes a top portion, a bottom portion, and two side portions, wherein the mounting structure includes two structural flange portions each having a first side coupled to a first side of the flange portion with one or more fasteners and a second side of the flange portion having the fastening member attached thereto.

11. The assembly of claim 1 wherein the frame is dimensioned for placement of a substantial portion of the rigid body between two upright structures of a cab of the vehicle and positioning the screen member approximately in a plane parallel to or the same as the plane defined by front surfaces of the two upright structures.

12. The assembly of claim 1 wherein the frame is configured from at least one structural material selected from the group consisting of a metal, aluminum, a composite, a plastic, and a vinyl.

13. A window assembly for a utility terrain vehicle (UTV) comprising:
a frame having a rigid body and four perimeter portions, each perimeter portion including a groove, the frame being dimensioned for positioning a portion of the frame between two upright supports of a cab of the vehicle;
an elongated spline member adapted for positioning within the grooves of the perimeter portions;
a screen member having a permeable body attached to the frame and having a portion of the screen member positioned within the grooves of each of the four perimeter portions and secured within the grooves by the spline member; and
a fastening hook and loop member attached to the frame and adapted for releasably coupling to an opposing hook and loop member of the vehicle.

14. The assembly of claim 13, further comprising a non-permeable member removably mounted to the frame and substantially parallel to the screen member.

15. The assembly of claim 13 wherein the frame includes a flange adapted for placement of the fastening hook and loop member with an adhesive and the frame being dimensioned for placement of a substantial portion of the rigid body between two upright structures of a cab of the vehicle and positioning the screen member approximately in a plane defined by or parallel to a plane defined by front surfaces of the two upright structures.

16. The assembly of claim 15 wherein the flange is an angle section attached to the rigid body with one or more fasteners.

17. The assembly of claim 13 wherein the frame includes a corner connector coupled to each of two of the adjacent perimeter portions for forming a rigid corner to the frame and forming the rigid body.

18. A window assembly for a utility terrain vehicle (UTV) comprising:
means for mounting a permeable screen to a rigid frame; and
means for releasably mounting the rigid frame with the permeable screen to a UTV vehicle.

19. The assembly of claim 18, further comprising means for selectably mounting a non-permeable member to the frame and substantially parallel to the permeable screen.

20. A utility terrain vehicle (UTV) comprising:
a vehicle assembly including an engine and frame;
a seat for a driver;
a load carrying platform behind the seat;
a cab frame surrounding the seat and having two upright supports positioned on either side of the seat;
first mating members attached to front surfaces of the two upright supports, the mating members having a first portion of a hook and loop fastening system; and
a screen shield having a rigid body defined by four perimeter portions, a screen member with a permeable body attached to the four perimeter portions of the frame, and second fastening members attached to the rigid body, the second fastening members having a second mating portion of the hook and loop fastening system that is opposite of that of the first mating members, the screen shield being adapted for releasably mounting to the two upright supports via the first and second mating members.

21. The vehicle of claim 20 wherein the screen shield includes a non-permeable member removably mounted to the rigid body and substantially parallel to the screen member.

22. The vehicle of claim 20 wherein the screen shield is first screen shield, the mating members are first mating members, and the two uprights are in front of the seat and wherein the cab frame includes two rear upright supports on either side of and behind the seat and in front of the load carrying platform, further comprising:
second mating members being attached to back surfaces of the two rear upright supports, the mating members having at least one portion of a hook and loop fastening system; and
a second screen shield having a rigid body with four perimeter portions, a second screen member with a permeable body attached to the four perimeter portions, and fastening members attached to the rigid body, the fastening members having a second mating portion of the hook and loop fastening system that is opposite of that of the second mating members, being adapted for releasably mounting to the two rear upright supports via the second mating members.

23. The vehicle of claim 22 wherein the second screen shield includes a non-permeable member removably mounted to the second rigid body and substantially parallel to the second screen member.

24. The vehicle of claim 20 wherein the mating members are configured from a flexible material attached to the upright supports by an adhesive.

25. The vehicle of claim 20 wherein the two upright supports do not include brackets adapted for mounting of the screen shield.
